(19) United States
(12) Patent Application Publication
(10) Pub. No.: US 2006/0006675 A1
(43) Pub. Date: Jan. 12, 2006

(54) Door jamb holding system

(76) Inventor: Robert Hendricks, Youngstown, OH (US)

Correspondence Address: Robert G. Lev, 4766 Michigan Boulevard, Youngstown, OH, 44505, US

(21) Appl. No.: 11/175,250

(22) Filed: Jul. 6, 2005

Related U.S. Application Data
(60) Provisional application No. 60/586,116, filed on Jul. 7, 2004.

(51) Int. Cl. E05C 19/18

(52) U.S. Cl. 292/288

(57) ABSTRACT

A door jamb holding system includes two identical pieces, which are sufficiently flexible in their adjustment with respect to each other and the doorjamb so that a wide variety of different sizes and configurations of doors and door jambs can be temporarily held together using the two piece system. Interlocking teeth on both pieces allow a very quick and secure locking between the two pieces to hold the door to the jamb even under considerable stress.

### RELATED APPLICATION

This application relies for priority upon Provisional Application No. 60/586,116, filed Jul. 7, 2004.

### FIELD OF THE INVENTION

The system of the present invention generally relates to holding pre-hung doors to their jambs or door frames. In particular, the present invention is directed to a flexible, easily used system to hold a wide variety of different sizes and configurations of door jambs and frames in a closed position.

### BACKGROUND OF THE INVENTION

Pre-hung doors have become a standard in the building industry. However, the latching and locking hardware for the door is usually purchased and installed separately. As a result, there is a tendency for the door to swing with relationship to the door frame, especially while being transported.

On construction sites with less than highly skilled labor, both the door and the jamb can easily be damaged if the door is not secured to the door jamb in a closed position until installation. Since the pre-hung door must be put into a number of different positions as it is moved, a secure fit between the door and its jamb is absolutely essential.

The simplest conventional technique for securing the door to the jamb prior to the installation of the pre-hung door and its locking hardware, is by driving nails through the jamb and into the door. These nails are later removed once the jamb is installed and nailed or screwed to the supporting studs.

The use of nails is highly undesirable. The finish on the edge of the door can be ruined, requiring a repair that may not be adequate. Further, clumsy use of the nails can also split the door jamb. Even if this does not occur, the doorjamb is weakened, thereby compromising the connection between the door jamb and the supporting studs of either structure.

There are a wide variety of devices for holding doors to door jambs without the destructive use of nails, staples, screws, and/or cleats. Most of them involve screw-type mechanisms whereby one type of piece fits on the outside of the doorjamb and is screwed into a second type of piece which has been inserted into the barrel (a hole bored in the door through which the latching hardware extends into the doorjamb). These require a close fit for the second part of the door holding device that is located within the barrel of the door. Very often, a tight fit is required.

If the barrel is long with respect to the hole that accommodates the door knob, fitting the second piece or receiver into the door barrel can be very awkward. The locking action can also be awkward since multiple screw rotations are necessary to obtain a tight fit between the door and the jamb. Further, if the diameter of the barrel is quite large, the head of the holding part on the outside of the doorjamb may not be sufficiently large to hold the doorjamb, necessitating additional pieces such as washers, and the like.

As on any construction site, connectors can be lost. Since two different kinds of hardware are required for most conventional doorjamb holders, replacement of lost part is often problematical. If more of one type of the connector are lost then the other, replacements can become awkward and expensive.

Other systems for holding door jambs include straps that wrap around the doorjamb and through the hole (for the knob) through the door. This is a fairly simple and inexpensive system. However, there are drawbacks. For example, the strap itself is often difficult to manipulate so as to hold the door and the jamb together. If the strap is made too tight, the door, or its finished might be damaged. Also, the strap may be difficult to remove when the jamb is being attached to supporting studs.

Likewise, removing the standard screw-in door jamb retainer may often be awkward when attaching the jamb to supporting studs. This can result in a loss of time to perform the door installation. A substantial improvement over the conventional art would include a door jamb holding system that can be easily removed, preferably without the time necessary to unscrew a typical conventional retainer. An improvement on the conventional art would also include a simplified retaining mechanism, having the capability of adjusting to a wide range of door configurations and sizes. The improved holding system would be very simple to install and capable of easy release when needed. Preferably, such a system would use only one type of hardware and would be simpler and far less expensive than conventional devices.

### SUMMARY OF THE INVENTION

Accordingly, it is an object of the present invention to improve upon conventional doorjamb holding systems.

It is another object of the present invention to provide a door jamb holding system that permits quick, simple connection.

It is a further object of the present invention to provide a reusable door jamb holding system.

It is an additional object of the present invention to provide relatively inexpensive door jamb holding system.

It is still another object of the present invention to provide door jamb holding system capable of adjusting to various door sizes.

It is again a further object of the present invention to provide a multi-piece door jamb holding system that uses only a single type of hardware.

It is again an additional object of the present invention to provide a door jamb holding system that is highly flexible.

It is yet another object of the present invention to provide a door jamb holding system having a simplified structure without having complex threading.

It is again a further object of the present invention to provide a door jamb holding system that is quickly released.

It is still an additional object of the present invention to provide a door jam holding system that can be installed or removed without the use of tools.

These and other goals and objects of the present invention are achieved by a door jamb holding system having two identical connectors, which have teeth arranged to interlock the two connectors in a complementary fashion.

### BRIEF DESCRIPTION OF THE DRAWINGS

FIG. 1 is a side view of one piece of the doorjamb holding system.

FIG. 2 is a top view of one piece of the door jamb holding system.

FIG. 3 in an end view of the base plate of one piece of the doorjamb holding system.

FIG. 4 is a side view of two pieces of the doorjamb holding system connector to each other in complementary fashion.

FIG. 5 is a second end view of one piece of the doorjamb holding system depicting the ends of two flexible arms.

### DETAILED DESCRIPTION OF THE PREFERRED EMBODIMENTS

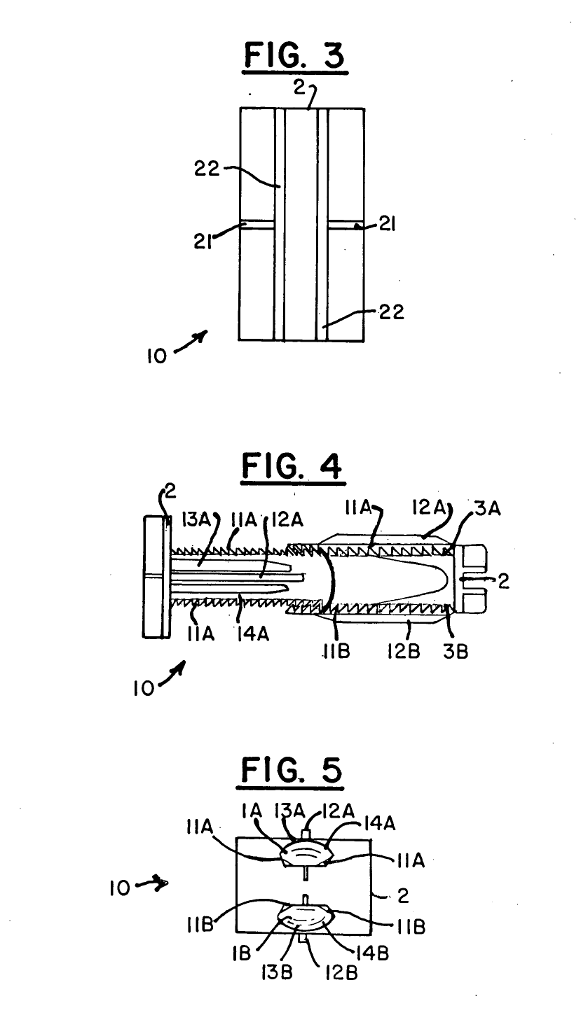

FIGS. 1 through 3 and 5 depict a single connector 10 of a two connector doorjamb holding system. Both connector pieces are identical and connect to each other as depicted in FIG. 4.

In order to make the connection depicted in FIG. 4, one of the two connecters 10 must be rotated about its longitudinal axis 90 degrees from the other connector. The two flexible arms 1(a), 1(b) of each connector will interact with each other on their peripheries (both bottom and sides), which contain teeth 11(a), 11(b). These teeth interlock with other complementary teeth on the other connector 10.

When oriented as depicted in FIG. 4, the two connectors 10 can easily be moved towards each other, continuously locking newly interfacing teeth 11(a), 11(b), As the connectors are moved together. This arrangement of two connectors 10 can not be directly pulled apart. However, the two flexible arms 1(a), 1(b) of each of the connectors are sufficiently flexible that the two can be twisted apart with relative ease, and without tools, when this is desired. Consequently, when the two connectors are being disconnected to free the door from the door jamb, it is not necessary to destroy either of the connectors. Further, the two connectors come apart very easily when twisted apart, allowing for a very quick disconnect, as well as a quick easy connection to each other.

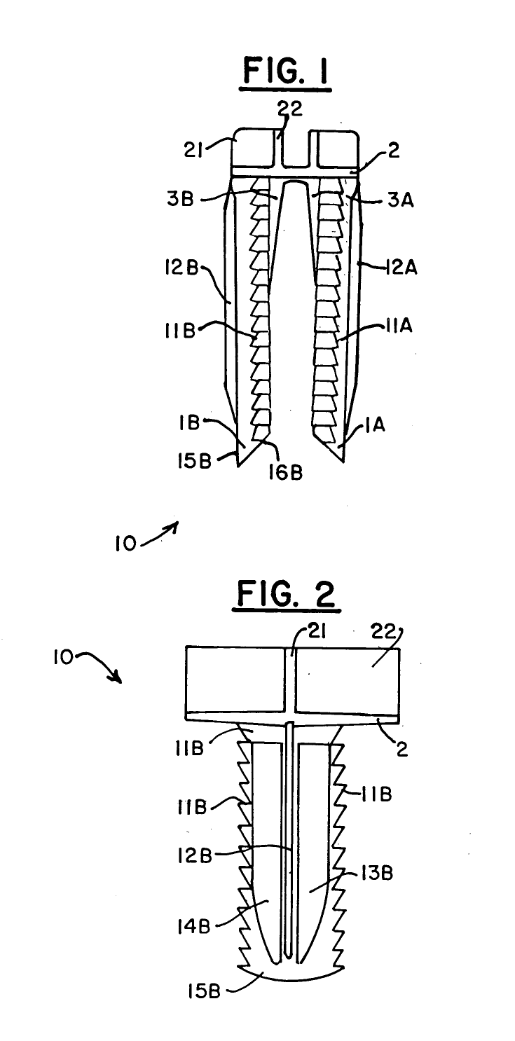

The unique holding arrangement of the present invention results from the extension, and thus operation, of the teeth in two different planes. As depicted in FIG. 1, the teeth extend downwards (towards those of the other flexible arm). However, these teeth also extend sideways as depicted in FIG. 2. FIG. 5 depicts the shape of the two flexible arms 1(a), 1(b) as seen from the end, with the teeth, 11(a), 11(b) operative in two directions. This allows two connectors 10 to be rotated about their longitudinal axes 90 degrees to each other so that they can be connected through the interaction of their teeth 11(a), 11(b). This interaction is facilitated further by the semi-circular shape of each of the arms.

The flexible arms 1(a), 1(b) are preferably made of a very flexible plastic so that they can move easily for both connecting and disconnecting. The flexible arms have an upper convex surface 15(b) and a lower flat surface 16(b) at the distal ends, as best depicted in FIGS. 1 and 5. This facilitates quick connection, while maintaining strength.

In order to make the highly flexible arms 1(a), 1(b) sufficiently stiff so that the configuration of FIG. 4 can be achieved, additional supports are necessary. The various support structures can be considered with reference to all of the drawings. This arrangement of supporting structures facilitates both strength and flexibility.

The two flexible arms 1(a), 1(b) are supported on a base 2. The base is relatively thin and wide so as to obtain good coverage of either the door latch bore or the door handle hole. While approximately 1¾ inches wide in one embodiment, the base can be virtually any width believed appropriate for holding a particular door to its doorjamb. Further, while the base is depicted as being rectangular in one preferred embodiment, it can also be square, or any other appropriate shape. Base vanes 21, 22 are used to support the base 2 to keep it from breaking or twisting.

While base vanes 22 are depicted as two parallel structures, with base vanes 21 extending laterally therefrom, this particular structure is not absolutely necessary for the operation of the present invention. Rather, almost any support structure can be used to help stiffen the base 2 to the desired extent.

As depicted in FIG. 5, base 2 supports two highly flexible arms 1(a), 1(b). these are in a roughly semi-circular cross section, into which teeth 11(a), 11(b) are formed on each side of each flexible arm. The flexible arms 1(a), 1(b) are not necessarily solid structures having semi-circular cross sections. Rather, parts of the cross section are hollowed out with concavities or depressions 13(b), 14(b). These concavities are arranged on either side of an outer support fin 12(b), as depicted in FIG. 2.

FIG. 1 depicts a side view including one outer support fin 12(a), 12(b) on each of the flexible arms 1(a), 1(b), respectively. On the opposite sides of the outer support fins 12(a), 12(b) on each flexible arm 1(a), 1(b) are inner support vanes 3(a), 3(b) respectively. These are best depicted in FIG. 1.

This arrangement of support vanes and fins provides the necessary stiffness so that the teeth 11(a), 11(b) of the two connectors 10 can lock securely together as shown in FIG. 4. Further the flexible arms 1(a), 1(b) are sufficiently pliable so that they are light and easy to both connect and disconnect. Because of the support structure (vanes and fins), the amount of material necessary for each connector can be reduced so that each connector is relatively inexpensive with respect to an alternative device that might be made with more material for a stiffer overall structure.

The connectors 10 of the inventive door jamb connecting system are preferably made of a light, flexible plastic material. However, any other material having the necessary flexibility and strength (to maintain the teeth in a locked position) can also be used. Examples include rubber, neoprene, or even lightweight wood. A key attribute is that the teeth extend in two directions (as best depicted in FIGS. 1 and 2) to facilitate the complementary locking depicted in FIG. 4.

While a number of embodiments have been described by way of example, the present invention is not confined thereto. Rather, the subject inventive door jamb restraining system should be considered to include any and all variations, modifications, permutations, adaptations, derivations, and embodiments that would occur to a skilled practitioner in this art once taught the present invention. Accordingly, the present invention should be interpreted as being limited only by the following claims.

I claim:

1. A door jam holding system, comprising:
(a) two identical locking pieces arranged to interface with each other.

2. The door jam holding system of claim 1, wherein said two identical pieces are connected together and attached without use of tools.

3. The door jam holding system of claim 1, wherein said two identical pieces are held together with complementary interlocking means on each of said two identical pieces.

4. The door jam holding system of claim 3, wherein said complementary interlocking means comprised sets of teeth extending in at least two directions.

5. The door jam holding system of claim 1, wherein one of said identical pieces fits through a door bull hole, and another of said two identical pieces extends through a door jam interface with said first identical piece.

6. This door jam holding system of claim 4, wherein each said two identical pieces has a main lateral axis, said two identical pieces fitted together by rotating said lateral axes 90 degrees with respect to each other.
